(19) United States
(12) Patent Application Publication
(10) Pub. No.: US 2013/0194718 A1
(43) Pub. Date: Aug. 1, 2013

(54) LAMINATED CERAMIC CAPACITOR AND METHOD FOR MANUFACTURING LAMINATED CERAMIC CAPACITOR

(71) Applicant: MURATA MANUFACTURING CO., LTD., Nagaokakyo-shi (JP)

(72) Inventor: Makoto Matsuda, Nagaokakyo-shi (JP)

(73) Assignee: MURATA MANUFACTURING CO., LTD., Nagaokakyo-shi (JP)

(21) Appl. No.: 13/804,798

(22) Filed: Mar. 14, 2013

Related U.S. Application Data
(63) Continuation of application No. PCT/JP2012/052943, filed on Feb. 9, 2012.

(30) Foreign Application Priority Data
Feb. 14, 2011 (JP) 2011-028982

(51) Int. Cl. H01G 4/30

(52) U.S. Cl. CPC H01G 4/30
USPC 361/301.4; 264/615

(57) ABSTRACT

Provided is a laminated ceramic capacitor having excellent lifetime characteristics in a high-temperature loading test. It includes a laminated body including a plurality of stacked dielectric layers including crystal grain and crystal grain boundaries, and a plurality of internal electrodes and external electrodes. The laminated body contains, as its main constituent, a perovskite-type compound containing Ba and Ti and optionally Ca, and further contains a rare-earth element R, and Mn, Mg, V, and Si With respect to 100 parts by mol the Ti, the total parts by mol content (100×m) of Ba and Ca is 0.950≦m<1.000, the contents in terms of parts by mol is 0.3≦R≦2.5, 0.05≦Mn≦0.5, 0.5≦Mg≦2.0, 0.05≦V≦0.25, 0.5≦Si≦3.0, and further, the molar ratio x of Ca/(Ba+Ca) is 0≦x≦0.01, and the existence of the rare-earth element R in a position of 4 nm inner from a surface of the crystal grain is 20% or more.

This is a continuation of application Ser. No. PCT/JP2012/052943, filed Feb. 9, 2012, the entire contents of which are incorporated herein by reference.

### TECHNICAL FIELD

The present invention relates to a laminated ceramic capacitor. In addition, the present invention relates to a method for manufacturing a laminated ceramic capacitor.

### BACKGROUND ART

With the recent progress of electronics technology, reduction in size and increase in capacitance have been required for laminated ceramic capacitors. In order to satisfy these requirements, a reduction in layer thickness has been used for dielectric layers of laminated ceramic capacitors. However, the reduction of the dielectric layers in layer thickness relatively increases the electric field intensity applied per layer. Therefore, improvements in reliability in the case of applying a voltage, and in particular, improvements in lifetime characteristics in a high-temperature loading test, have been required for the dielectric ceramic used in the dielectric layers.

As one of these laminated ceramic capacitors, the laminated ceramic capacitor disclosed in Patent Document 1 is known, for example. Patent Document 1 discloses a laminated ceramic capacitor including a capacitor main body obtained by alternately stacking dielectric layers composed of main crystal grains and a grain boundary phase and internal electrode layers, where the main crystal grains contain Ba and Ti as its main constituent, and include BCT crystal grains with a Ca component concentration of 0.4 atomic % or more and a Zr component concentration of 0.2 atomic % or less, and BCTZ crystal grains with a Ca component concentration of 0.4 atomic % or more and a Zr component concentration of 0.4 atomic % or more, when the relationship of A/B≧1.003 is satisfied and the total amount of Ba and Ca in the dielectric layers is expressed by A mol, and the total amount of Ti or of Ti and Zr is expressed by B mol. This composition is supposed to suppress the grain growth of the BCTZ crystal grains and BCT crystal grains, and achieve laminated ceramic capacitors which can improve the characteristics in high-temperature loading tests.

### PRIOR PATENT DOCUMENT

Patent Document 1: JP 2006-179774 A

### DISCLOSURE OF THE INVENTION

### Problem to be Solved by the Invention

The dielectric layers disclosed in Patent Document 1 have an A/B ratio of 1.003 or more, which means that the total amount of Ba and Ca is larger than the total amount of Ti and Zr, thus leading to a problem that insulation degradation is more likely to take place in high-temperature loading tests while abnormal grain growth is suppressed.

The present invention has been achieved in view of the problem, and an object of the present invention is to provide a laminated ceramic capacitor which has a favorable dielectric property and produces excellent lifetime characteristics in a high-temperature loading test, even when a voltage with a high electric field intensity is applied to dielectric layers further reduced in thickness.

### Means for Solving the Problem

A laminated ceramic capacitor according to the present invention includes: a laminated body comprising a plurality of stacked dielectric layers including a crystal grain and a crystal grain boundary, and a plurality of internal electrodes formed along interfaces between the dielectric layers; and a plurality of external electrodes formed on an outer surface of the laminated body and electrically connected to the internal electrodes, and the laminated ceramic capacitor is characterized in that the laminated body has a composition which contains, as its main constituent, a perovskite-type compound containing Ba and Ti and optionally containing Ca, and further contains a rare-earth element R, and Mn, Mg, V, and Si, and with respect to 100 parts by mol of the Ti, the total content (100×m) of the Ba and the Ca is 0.950≦m<1.000 in terms of parts by mol, the content a of the R is 0.3≦a≦2.5 in terms of parts by mol, the content b of the Mn is 0.05≦b≦0.5 in terms of parts by mol, the content c of the Mg is 0.5≦c≦2.0 in terms of parts by mol, the content d of the V is 0.05≦d≦0.25 in terms of parts by mol, the content e of the Si is 0.5≦e≦3.0 in terms of parts by mol, further, the molar ratio x of Ca/(Ba+Ca) is 0≦x≦0.10, and further, the existence of the rare-earth element R is 20% or more in a position of 4 nm inner from a surface of the crystal grain.

In addition, another laminated ceramic capacitor according to the present invention includes: a laminated body comprising a plurality of stacked dielectric layers including a crystal grain and a crystal grain boundary, and a plurality of internal electrodes formed along interfaces between the dielectric layers; and a plurality of external electrodes formed on an outer surface of the laminated body and electrically connected to the internal electrodes, and the laminated ceramic capacitor is characterized in that the laminated body has a composition which contains, as its main constituent, a perovskite-type compound containing Ba and Ti and optionally containing Ca, and further contains a rare-earth element R, and Mn, Mg, V, and Si, and in case the laminated body is dissolved in a solvent, when the content of the Ti is regarded as 100 parts by mol, the total content (100×m) of the Ba and the Ca is 0.950≦m<1.000 in terms of parts by mol, the content a of the R is 0.3≦a≦2.5 in terms of parts by mol, the content b of the Mn is 0.05≦b≦0.5 in terms of parts by mol, the content c of the Mg is 0.5≦c≦2.0 in terms of parts by mol, the content d of the V is 0.05≦d≦0.25 in terms of parts by mol, the content e of the Si is 0.5≦e≦3.0 in terms of parts by mol, further, the molar ratio x of Ca/(Ba+Ca) is 0≦x≦0.10, and further, the existence of the rare-earth element R is 20% or more in a position of 4 nm inner from a surface of the crystal grain.

In addition, yet another laminated ceramic capacitor according to the present invention includes: a laminated body comprising a plurality of stacked dielectric layers including a crystal grain and a crystal grain boundary, and a plurality of internal electrodes formed along interfaces between the dielectric layers; and a plurality of external electrodes formed on an outer surface of the laminated body and electrically connected to the internal electrodes, and the laminated ceramic capacitor is characterized in that the dielectric layers have a composition which contains, as its main constituent, a perovskite-type compound containing Ba and Ti and optionally containing Ca, and further contains a rare-earth element R, and Mn, Mg, V, and Si, with respect to 100 parts by mol of the Ti, the total content (100×m) of the Ba and the Ca is 0.950≦m<1.000 in terms of parts by mol, the content a of the R is 0.3≦a≦2.5 in terms of parts by mol, the content b of the Mn is 0.05≦b≦0.5 in terms of parts by mol, the content c of the Mg is 0.5≦c≦2.0 in terms of parts by mol, the content d of the V is 0.05≦d≦0.25 in terms of parts by mol, the content e of the Si is 0.5≦e≦3.0 in terms of parts by mol, further, the molar ratio x of Ca/(Ba+Ca) is 0≦x≦0.10, and further, the existence of the rare-earth element R is 20% or more in a position of 4 nm inner from a surface of the crystal grain.

Still further, the dielectric layers are preferably 0.4 μm or more and 1.5 μm or less in thickness in the laminated ceramic capacitor according to the present invention.

A method for manufacturing a laminated ceramic capacitor according to the present invention includes the steps of: preparing a main constituent powder which contains, as its main constituent, a perovskite-type compound containing Ba and Ti and optionally containing Ca; preparing a compound of a rare-earth element R, and a Mn compound, a Mg compound, a V compound, and a Si compound; mixing the main constituent powder, the compound of the rare-earth element R, and the Mn compound, the Mg compound, the V compound, and the Si compound to obtain ceramic slurry; obtaining a ceramic green sheet from the ceramic slurry; stacking the ceramic green sheet and an internal electrode layer to obtain an unfired laminated body; and firing the unfired laminated body to obtain a laminated body with an internal electrode formed between dielectric layers, and the method is characterized in that, with respect to 100 parts by mol of the Ti, the total content (100×m) of the Ba and the Ca is 0.950≦m<1.000 in terms of parts by mol, the content a of the R is 0.3≦a≦2.5 in terms of parts by mol, the content b of the Mn is 0.05≦b≦0.5 in terms of parts by mol, the content c of the Mg is 0.5≦c≦2.0 in terms of parts by mol, the content d of the V is 0.05≦d≦0.25 in terms of parts by mol, the content e of the Si is 0.5≦e≦3.0 in terms of parts by mol, further, the molar ratio x of Ca/(Ba+Ca) is 0≦x≦0.10, further, the dielectric layers include a crystal grain and a crystal grain boundary, and the existence of the rare-earth element R is 20% or more in a position of 4 nm inner from a surface of the crystal grain.

### Advantageous Effect of the Invention

The dielectric ceramic according to the present invention has the composition as described above, and contains the rare-earth element in a proportion of 20 mol % or more in a position of 4 nm inner from the surface of the crystal grains, thereby making it possible to provide a laminated ceramic capacitor which produces excellent lifetime characteristics in a high-temperature loading test even when a voltage with a high electric field intensity is applied to dielectric layers further reduced in thickness.

### BRIEF EXPLANATION OF DRAWINGS

FIG. 1 is a cross-sectional view illustrating a laminated ceramic capacitor according to the present invention.

FIG. 2 is a diagram illustrating points for the measurement of the thickness for dielectric layers in Experimental Example 1.

### BEST MODE FOR CARRYING OUT THE INVENTION

An embodiment for carrying out the present invention will be described below.

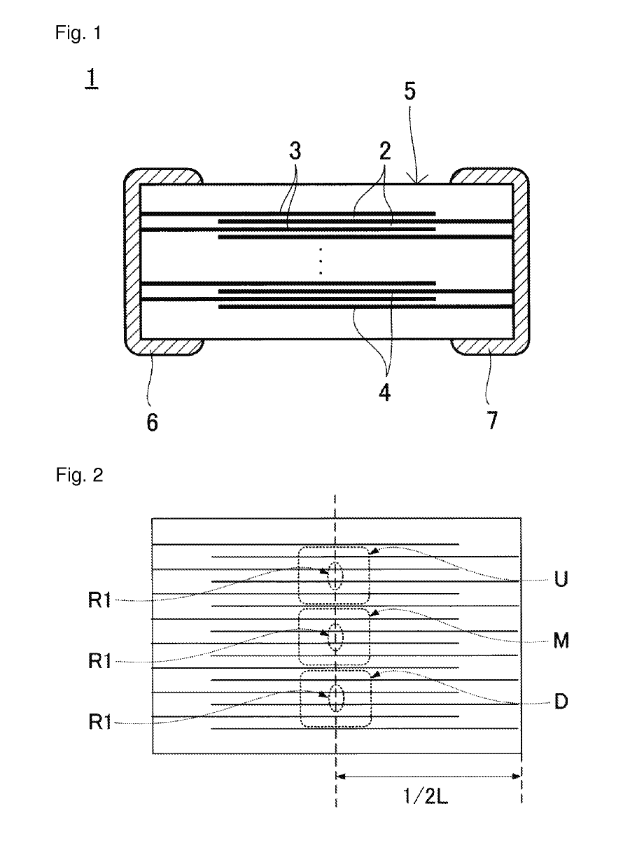

FIG. 1 is a cross-sectional view of a laminated ceramic capacitor according to the present invention.

The laminated ceramic capacitor 1 includes a laminated body 5. The laminated body 5 includes a plurality of stacked dielectric layers 2, and a plurality of internal electrodes 3 and 4 formed along interfaces between the plurality of dielectric layers 2. Materials for the internal electrodes 3 and 4 include, for example, materials containing Ni as their main constituent.

External electrodes 6 and 7 are formed in different positions from each other on the outer surface of the laminated body 5. Materials for the external electrodes 6 and 7 include, for example, materials containing Ag or Cu as their main constituent. In the case of the laminated ceramic capacitor shown in FIG. 1, the external electrodes 6 and 7 are formed on respective end surfaces of the laminated body 5, which are opposed to each other. The internal electrodes 3 and 4 are electrically connected respectively to the external electrodes 6 and 7. Further, the internal electrodes 3 and 4 are stacked alternately with the dielectric layers 2 interposed therebetween in the laminated body 5.

It is to be noted that the laminated ceramic capacitor 1 may be a two-terminal capacitor including two external electrodes 6 and 7, or may be a multi-terminal capacitor including a larger number of external electrodes.

The dielectric ceramic constituting the dielectric layers 2 contains, as its main constituent, a perovskite-type compound containing Ba and Ti and optionally containing Ca, further contains a rare-earth element R and Mn, Mg, V, and Si, includes a composition in which the total content (100×m) of the Ba and the Ca is 0.950≦m<1.000 in terms of parts by mol, the content a of the R is 0.3≦a≦2.5 in terms of parts by mol, the content b of the Mn is 0.05≦b≦0.5 in terms of parts by mol, the content c of the Mg is 0.5≦c≦2.0 in terms of parts by mol, the content d of the V is 0.05≦d≦0.25 in terms of parts by mol, the content e of the Si is 0.5≦e≦3.0 in terms of parts by mol, and further, the molar ratio x of Ca/(Ba+Ca) is represented by 0≦x≦0.10, with respect to 100 parts by mol of the Ti, and includes crystal grains and crystal grain boundaries. The dielectric ceramic is further characterized in that the existence rare-earth element is 20% or more in a position of 4 nm inner from the surface of the crystal grains. The existence is calculated in accordance with the following procedure. First, a composition analysis is carried out for 100 points in positions which are within 4 nm from the surface of the crystal grains. Then, the presence or absence of the rare-earth element is determined at each of the points, and the ratio of points with the element present is regarded as the existence percentage of the rare-earth element.

In the present invention, the molar ratio of the total amount of Ba and Ca to Ti is 0.950≦m<1.000, which is lower than the stoichiometric composition. In addition, due to the fact that the existence of the rare-earth element is not less than the certain percentage in the position close to the surface of the crystal grains, a dielectric ceramic can be achieved which produces excellent lifetime characteristics in a high-temperature loading test.

It is to be noted that the R (rare earth), Mn, Mg, V, and Si may be present in any form. The R (rare earth), Mn, Mg, V, and Si may be present as oxides at grain boundaries, or as solid solutions in the main constituent grains.

In addition, the dielectric layers 2 are preferably 0.4 μm or more and 1.5 μm or less in thickness in the laminated ceramic capacitor according to the present invention. The laminated ceramic capacitor according to the present invention remarkably produces the effect of the present invention in this thickness range.

The raw material powder for the dielectric ceramic is prepared, for example, by a solid-phase synthesis method. Specifically, first, compound powders such as oxides and carbonates including constituent elements for the main constituent are mixed in predetermined proportions, and subjected to calcination. It is to be noted that a hydrothermal method or the like may be applied, in addition to the solid-phase synthesis method. Further, alkali metals, transition metals, Cl, S, P, Hf, etc. may be contained in the dielectric ceramic according to the present invention to such an extent that the effect of the present invention is not hindered.

The laminated ceramic capacitor is, for example, manufactured as follows. The raw material powder for the dielectric ceramic, which is obtained in the way described above, is used to prepare a ceramic slurry. Then, ceramic green sheets are formed by a sheet forming method or the like. A conductive paste to serve as internal electrodes is then applied by printing or the like onto predetermined ceramic green sheets among the plurality of ceramic green sheets. The plurality of ceramic green sheets is stacked and subjected to pressure bonding to obtain a raw laminated body. Next, the raw laminated body is subjected to firing. This firing step provides dielectric layers composed of the dielectric ceramic. Thereafter, external electrodes are formed by baking or the like on end surfaces of the laminated body.

Next, experimental examples will be described which were carried out according to the present invention.

### Experimental Example 1

### (A) Preparation of Raw Material Powder for Dielectric Ceramic

First, a barium titanate (hereinafter, BT) powder and a barium calcium titanate (hereinafter, BCT) powder were prepared as main constituents. Specifically, a BaCO₃ powder, a CaCO₃ powder, and a TiO₂ powder were weighed for a molar ratio m of the total content of Ba and Ca to Ti and the molar ratio Ba: Ca=1−x: x between the contents of Ba and Ca. These weighed powders were mixed for 24 hours in a ball mill, and then subjected to a heat treatment to obtain a BT powder and a BCT powder as main constituents. The average grain sizes of the BT powder and the BCT powder were controlled to approximately 100 nm by controlling the grain sizes of the BaCO₃, CaCO₃, and TiO₂, and the heat treatment temperature.

Respective powders of Dy₂O₃, MnO, MgO, V₂O₃, and SiO₂ were prepared as accessory constituents. These powders were weighed so that the Dy content, Mn content, Mg content, V content, and Si content were respectively a, b, c, d, and e in parts by mol with respect to 100 parts by mol of Ti in the BT powder or BCT powder as the main constituent, blended with the BT powder or BCT powder as the main constituent, and subjected to mixing for 5 hours in a ball mill, and then to drying and dry grinding. In this way, raw material powders for the dielectric ceramic were obtained. Table 1 shows the values of m, x, a, b, c, d, and e for samples under each experimental condition.

Further, it has been confirmed by an ICP emission spectrometric analysis that the obtained raw material powders are nearly identical to the prepared compositions shown in Table 1.

### (B) Preparation of Laminated Ceramic Capacitor

First, ceramic green sheets to serve as dielectric layers were formed. Specifically, the raw material powder described above was subjected to wet mixing in a ball mill with the addition of a polyvinyl butyral based binder and an organic solvent such as ethanol to the powder, thereby preparing ceramic slurry. Then, this ceramic slurry was formed into the shape of a sheet with the use of a die coater so that the thickness of a dielectric layer after firing reached a predetermined thickness, thereby providing ceramic green sheets.

Next, a conductive paste containing Ni as its main constituent was applied by printing onto predetermined ceramic green sheets to form conductive paste layers to serve as internal electrodes. The conductive paste layers were prepared so that the internal electrodes were 0.4 μm in thickness after firing.

The resulting ceramic green sheets were stacked so as to alternate the sides to which the conductive paste layers were drawn (exposed), thereby forming a raw laminated body. The number of stacked ceramic green sheets was 100.

Next, the binder was burned off by heating at 300° C., and then increasing the temperature to 700° C. in a N₂ atmosphere. After that, the raw laminated body was subjected to firing in accordance with a profile of increasing at a rate of temperature increase: 100° C./min, keeping at a maximum temperature of 1200° C. for 1 minute, and then decreasing the temperature. It is to be noted that the firing was carried out in a reducing atmosphere composed of a H₂—N₂—H₂O gas with an oxygen partial pressure of 10⁻¹⁰ MPa.

These fired laminated body was dissolved, and subjected to an ICP emission spectrometric analysis to confirm that the body is nearly identical to the prepared composition shown in Table 1, except for Ni as an internal electrode constituent.

Next, a copper paste containing B₂O₃—Li₂O—SiO₂—BaO glass frit was applied onto both end surfaces of the fired laminated body. Then, baking was carried out at 800° C. in a N₂ atmosphere to form external electrodes electrically connected to the internal electrodes.

The laminated ceramic capacitor prepared in the way described above had external dimensions of 1.0 mm×0.5 mm×0.5 mm, and the area of the electrode opposed per layer was 0.3 mm². In addition, the crystal grains in the dielectric layers constituting the laminated ceramic capacitor had an average grain size of 100 nm to 200 nm. It is to be noted that in a method for measuring the average grain size, the laminated ceramic capacitor was fractured, and subjected to a heat treatment for clearly identifying crystal grain boundaries, and the fractured surface was observed with the use of a scanning microscope. In Experimental Example 1 herein, the temperature for the heat treatment was adjusted to 1000° C. Then, this observed image was subjected to an image analysis to measure the grain sizes of the crystal grains with the equivalent circle diameters of the crystal grains as the grain sizes. Then, for each sample, the grain sizes of one-hundred crystal grains were measured to calculate the average value as an average grain size.

### (C) Characterization

First, the existence probability of Dy was calculated in a position of 4 nm inner from the surface of the crystal grains.

First, the laminated ceramic capacitor was reduced in layer thickness by an ion milling method.

Next, the exposed cross section was observed by TEM to search crystal grain boundaries substantially perpendicular to the cross section. Specifically, lines appearing on each side of crystal grain boundaries, that is, Fresnel fringes were observed by TEM to search crystal grain boundaries with the Fresnel fringes nearly symmetrically changed on each side thereof in contrast, that is, crystal grain boundaries with the Fresnel fringes nearly symmetrically changed on each side thereof into bright lines or dark lines in the case of varying the focus, and the crystal grain boundaries were regarded as crystal grain boundaries substantially perpendicular to the cross section.

Then, crystal grain boundaries substantially perpendicular to the cross section were found at 20 points from different grains, and the positions each 4 nm away from the respective crystal grain boundaries on the inside of the crystal grains were each regarded as a “position of 4 nm inner from the surface of the crystal grain”, and subjected to a composition analysis with the use of STEM-EDX (probe diameter: 2 nm). For each of crystal grain boundaries substantially perpendicular to twenty cross sections, both sides of the boundaries were subjected to the composition analysis, meaning that forty points in total were subjected to the composition analysis.

Then, the presence or absence of Dy was determined at the respective analyzed points, and the ratio of points with Dy present was regarded as the existence or “existence probability” of Dy.

Next, the thickness for the dielectric layers was determined for the samples under each experimental condition.

First, each sample was put perpendicularly, and surrounded and fixed with a resin. In this case, the resin was used so as to expose the LT side surface (length-height side surface: side surface from which the internal electrodes including sections connecting to the external electrode are exposed when polishing is carried out) of each sample. The LT cross section was exposed by polishing the LT side surface with a polishing machine, and completing the polishing at ½ of the depth in the W direction (width direction) of the laminated body. This polished surface was subjected to ion milling to remove sag produced by the polishing. In this way, the cross sections for observation were obtained.

As illustrated in FIG. 2, a line perpendicular to the internal electrodes was drawn at ½ in the L direction (length direction) of the LT cross section. Next, a region of the sample with the internal electrodes stacked was divided equally in the T direction (height direction) into three regions of: upper section U; middle section M; and lower section D. Then, twenty-five dielectric layers were selected from a central section in the height direction of each region (a region including the twenty-five dielectric layers is shown as a measurement region R1 in FIG. 2), and the thickness for these dielectric layers was measured on the perpendicular line. However, layers were excluded when they were unmeasurable due to the fact such as that the defective internal electrode on the perpendicular line made a connection between the ceramic layers sandwiching the internal electrode.

For each sample, the thickness for the dielectric layers was measured at seventy-five points to obtain the average value of the measurements.

The thickness for the dielectric layers was measured with the use of a scanning electron microscope.

Next, the dielectric constant was obtained for the laminated ceramic capacitors according to each experimental condition. Specifically, the electrostatic capacitance was measured for fifty samples with the use of HP4268 from Agilent Technologies, Inc. under the conditions of temperature: 25° C.; 1 kHz; and 0.5 Vrms. Then, the dielectric constant was calculated from the average value of the measurement, the thickness of the dielectric layer, the number of layers, and the opposed electrode area.

A high-temperature loading test was carried out under the conditions of 85° C. temperature and 10 kV/mm electric field intensity. Any sample whose insulation resistance decreased to 100 kΩ or less prior to a lapse of 2000 hours was regarded as a defective. The high-temperature loading test was carried out for 100 samples.

Table 1 shows the results of various types of characterization for samples according to each experimental condition. It is to be noted that the sample numbers marked with * in Table 1 refer to samples which fall outside the scope of the present invention.

TABLE 1

| | | | | | | | | Laminated Ceramic Capacitor | | | |
|---|---|---|---|---|---|---|---|---|---|---|---|
| | | | | | | | | | | | The Number |
| | | | | | | | | | | | of |
| | | | | | | | | | | | Defectives |
| | | | | | | | | | Existence | | in High- |
| | | | | | | | | | Probability | | Temperature |
| | | | | | | | | Dielectric | of Dy 4 nm | | Loading |
| Sample | Dielectric Ceramic | | | | | | | Layer | Inner from | Dielectric | Test |
| Number | m | x | a | b | c | d | e | Thickness | Surface | Constant | (number) |
| 1 | 0.990 | 0 | 1.0 | 0.05 | 1.0 | 0.15 | 1.5 | 1.5 μm | 28% | 3200 | 0/100 |
| 2 | 0.960 | 0 | 1.0 | 0.05 | 1.0 | 0.15 | 1.5 | 1.5 μm | 36% | 3300 | 0/100 |
| 3* | 1.010 | 0 | 1.0 | 0.05 | 1.0 | 0.15 | 1.5 | 1.5 μm | 3% | 2800 | 10/100 |
| 4* | 1.003 | 0 | 1.0 | 0.05 | 1.0 | 0.15 | 1.5 | 1.5 μm | 5% | 2900 | 7/100 |
| 5 | 0.985 | 0.10 | 0.3 | 0.1 | 0.5 | 0.25 | 0.5 | 1.5 μm | 20% | 4000 | 0/100 |
| 6 | 0.950 | 0.10 | 0.3 | 0.1 | 0.5 | 0.25 | 0.5 | 1.5 μm | 27% | 4200 | 0/100 |
| 7* | 1.009 | 0.10 | 0.3 | 0.1 | 0.5 | 0.25 | 0.5 | 1.5 μm | 1% | 3500 | 35/100 |
| 8* | 1.000 | 0.10 | 0.3 | 0.1 | 0.5 | 0.25 | 0.5 | 1.5 μm | 2% | 3600 | 11/100 |
| 9 | 0.999 | 0 | 2.5 | 0.5 | 2.0 | 0.05 | 3.0 | 0.4 μm | 35% | 2500 | 0/100 |
| 10 | 0.970 | 0 | 2.5 | 0.5 | 2.0 | 0.05 | 3.0 | 0.4 μm | 52% | 2700 | 0/100 |
| 11* | 1.007 | 0 | 2.5 | 0.5 | 2.0 | 0.05 | 3.0 | 0.4 μm | 5% | 2000 | 100/100 |
| 12* | 1.003 | 0 | 2.5 | 0.5 | 2.0 | 0.05 | 3.0 | 0.4 μm | 8% | 2100 | 80/100 |

In the case of sample numbers 1 to 4, the main constituent is BT, and the dielectric layer is 1.5 μm in thickness. In sample numbers 1 and 2, the molar ratio m of Ba to Ti is less than 1. These cases where the existence probability of Dy 4 nm inner from the surface of the crystal grains is 28% and 36%, respectively, also exhibited favorable lifetime characteristics in the high-temperature loading test. On the other hand, sample numbers 3 and 4 with m of 1 or more caused defectives in the high-temperature loading test. In addition, the dielectric constant is also decreased as compared with sample numbers 1 and 2.

In the case of sample numbers 5 to 8, the main constituent is BCT, and the dielectric layer is 1.5 μm in thickness. In sample numbers 5 and 6, the molar ratio m of the total amount of Ba and Ca to Ti is less than 1. These cases where the existence probability of Dy 4 nm inner from the surface of the crystal grains is 20% and 27%, respectively, also exhibited favorable lifetime characteristics in the high-temperature loading test. On the other hand, sample numbers 7 and 8 with m of 1 or more caused defectives in the high-temperature loading test.

In the case of sample numbers 9 to 12, the main constituent is BT, and the dielectric layer is 0.4 μm in thickness. In sample numbers 9 and 10, the molar ratio m of Ba to Ti is less than 1. These cases where the existence probability of Dy 4 nm inner from the surface of the crystal grains is 35% and 52%, respectively, also exhibited favorable lifetime characteristics in the high-temperature loading test. On the other hand, sample numbers 11 and 12 with m of 1 or more caused defectives in the high-temperature loading test.

### DESCRIPTION OF REFERENCE SYMBOLS

1 laminated ceramic capacitor

2 dielectric layer

3, 4 internal electrode

5 laminated body

6, 7 external electrode

1. A laminated ceramic capacitor comprising:
a laminated body comprising a plurality of stacked dielectric layers comprising a crystal grain and a crystal grain boundary, and a plurality of internal electrodes formed along the interfaces between the dielectric layers; and
a plurality of external electrodes formed on an outer surface of the laminated body and electrically connected to the internal electrodes,
wherein the laminated body has a composition which contains, as its main constituent, a perovskite-type compound containing Ba and Ti and optionally containing Ca, and further contains rare-earth element R, and Mn, Mg, V, and Si,
in terms of parts by mol with respect to 100 parts by mol of the Ti:
the total content (100×m) of the Ba and the Ca is 0.950≦m<1.000,the content a of the R is 0.3≦a≦2.5, the content b of the Mn is 0.05≦b≦0.5,the content c of the Mg is 0.5≦c≦2.0,the content d of the V is 0.05≦d≦0.25, and the content e of the Si is 0.5≦e≦3.0, the molar ratio x of Ca/(Ba+Ca) is 0≦x≦0.10, and the existence of the rare-earth element R in a position of 4 nm inner from a surface of the crystal grain is 20% or more.

2. A laminated ceramic capacitor comprising according to claim 1 in which said contents and molar ratio are when the laminated body is dissolved in a solvent.

3. A laminated ceramic capacitor according to claim 1, wherein the dielectric layers comprise said composition.

4. The laminated ceramic capacitor according to claim 3, wherein the dielectric layers are 0.4 μm to 1.5 μm in thickness.

5. The laminated ceramic capacitor according to claim 4, wherein the Ca is present.

6. The laminated ceramic capacitor according to claim 4, wherein the Ca is absent.

7. The laminated ceramic capacitor according to claim 2, wherein the dielectric layers are 0.4 μm to 1.5 μm in thickness.

8. The laminated ceramic capacitor according to claim 7, wherein the Ca is present.

9. The laminated ceramic capacitor according to claim 7, wherein the Ca is absent.

10. The laminated ceramic capacitor according to claim 1, wherein the dielectric layers are 0.4 μm to 1.5 μm in thickness.

11. The laminated ceramic capacitor according to claim 10, wherein the Ca is present.

12. The laminated ceramic capacitor according to claim 11, wherein R is Dy.

13. The laminated ceramic capacitor according to claim 10, wherein the Ca is absent.

14. The laminated ceramic capacitor according to claim 13, wherein R is Dy.

15. A method for manufacturing a laminated ceramic capacitor comprising providing a mixture of a main constituent powder, a rare-earth element R, a Mn compound, a Mg compound, a V compound, and a Si compound, wherein the main constituent powder contains, as its main constituent, a perovskite-type compound containing Ba and Ti and optionally containing Ca; and in terms of parts by mol with respect to 100 parts by mol of the Ti, the total content (100×m) of the Ba and the Ca is 0.950≦m<1.000, the content a of the R is 0.3≦a≦2.5, the content b of the Mn is 0.05≦b≦0.5,the content c of the Mg is 0.5≦c≦2.0, the content d of the V is 0.05≦d≦0.25, and the content e of the Si is 0.5≦e≦3.0, the molar ratio x of Ca/(Ba+Ca) is 0≦x≦0.10;
forming a ceramic slurry with the mixture;
forming a ceramic green sheet from the ceramic slurry;
stacking a plurality of ceramic green sheets and at least two internal electrode layers at different interfaces between sheets to obtain an unfired laminated body; and
firing the unfired laminated body to obtain a laminated body with an internal electrode formed between dielectric layers,
wherein the dielectric layers include a crystal grain and a crystal grain boundary, and the existence of the rare-earth element R in a position of 4 nm inwardly from a surface of the crystal grain is 20% or more.
